(19) United States
(12) Patent Application Publication
(10) Pub. No.: US 2010/0207335 A1
(43) Pub. Date: Aug. 19, 2010

(54) Tool with a Chuck

(76) Inventor: Jack Lin, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/389,234

(22) Filed: Feb. 19, 2009

(51) Int. Cl. B25G 3/02

(52) U.S. Cl. 279/22

(57) ABSTRACT

A tool includes a handle and a chuck. The chuck includes a socket, a sleeve located on the socket. The socket includes a recess, an aperture in communication with the recess, chutes in communication with the recess, and a groove in an external side. The sleeve includes front, middle and rear shoulders on an internal side. A C-clip is located within the groove. A first stopping ring is abutted against the front shoulder. The C-clip is located between second and third stopping rings. A small ball is located in the aperture of the socket and restrained with the front shoulder. Large balls are movably located in the chutes. A pushing ring is located against the large balls. A first elastic element is compressed between the second stopping ring and the pushing ring. A second elastic element is compressed between the third stopping ring and the rear shoulder.

### FIELD OF INVENTION

The present invention relates to a tool and, more particularly, to a tool including a handle and a chuck for easily holding and releasing a bit.

### BACKGROUND OF INVENTION

A conventional tool includes a socket securely inserted in a handle. Before operation, a first end of a bit is fit in the socket while an opposite second end of the bit is located outside the socket. The bit may be an Allen key, a flat screwdriver, a cruciform screwdriver or a square screwdriver depending on a fastener such as a nut or screw to be driven with the tool. In operation, the tool is operable to drive the fastener. After operation, the bit is removed from the socket.

The first end of the bit is simply fit in the socket before the operation. In the operation, the tool is subject to a torque. A large torque would cause the first end of the bit to be stuck in the socket. In this case, it would be difficult to remove the first end of the bit out of the socket with bare hands. A pincer would be needed to remove the first end of the bit out of the socket, and this is inconvenient.

The present invention is therefore intended to obviate or at least alleviate the problems encountered in prior art.

### SUMMARY OF INVENTION

It is the primary objective of the present invention to provide a tool with a handle and a chuck for easily holding and releasing a bit.

To achieve the foregoing objective, the chuck includes a socket and a sleeve located on the socket. First, second and third stopping rings, a pushing ring, and first and second elastic elements are located between the socket and the sleeve. The socket includes a recess defined therein, an aperture in communication with the recess, chutes in communication with the recess, and a groove in an external side. The sleeve includes front, middle and rear shoulders on an internal side. An internal diameter of a section of the sleeve between the front and middle shoulders is smaller than that of a section of the sleeve between the middle and rear shoulders. A C-clip is located in the groove. The first stopping ring is abutted against the front shoulder. The C-clip is located between the second and third stopping rings. The small ball is located in the aperture and restrained with the front shoulder. The large balls are movably located in the chutes. The pushing ring is located against the large balls. The first elastic element is compressed between the second stopping ring and the pushing ring. The second elastic element is compressed between the third stopping ring and the rear shoulder.

Other objectives, advantages and features of the present invention will be apparent from the following description referring to the attached drawings.

### BRIEF DESCRIPTION OF DRAWINGS

The present invention will be described via detailed illustration of the embodiments referring to the drawings.

FIG. 1 is a perspective view of a tool according to a first embodiment of the present invention.

FIG. 2 is an exploded view of the tool shown in FIG. 1.

FIG. 3 is a cross-sectional view of the tool shown in FIG. 1.

FIG. 4 is a cross-sectional view of the tool in another position than shown in FIG. 3.

FIG. 5 is a cross-sectional view of the tool in another position than shown in FIG. 4.

FIG. 6 is a cross-sectional view of the tool in another position than shown in FIG. 5.

FIG. 7 is a side view of a tool according to a second embodiment of the present invention.

### DETAILED DESCRIPTION OF EMBODIMENTS

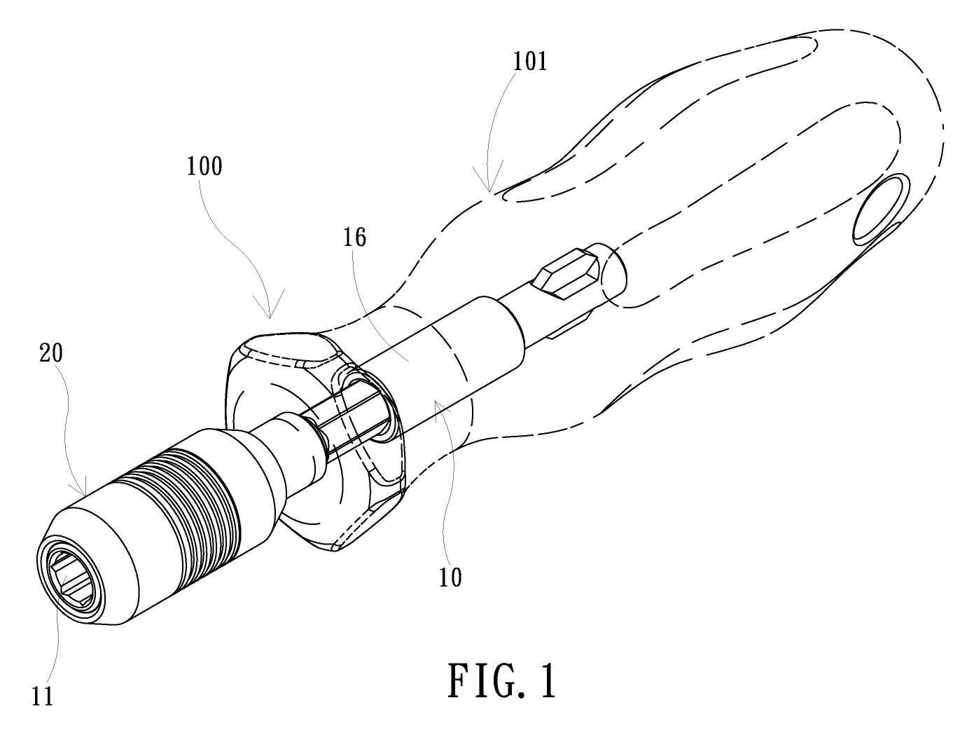

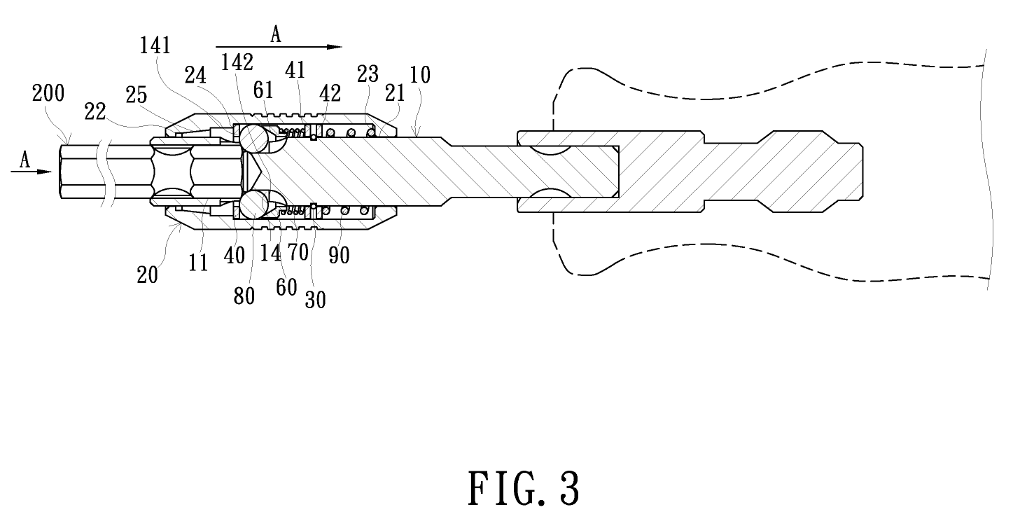

Referring to FIG. 1, a tool includes a handle 101 and a chuck 100 for easily holding and releasing a bit 200 (FIG. 3) according to a first embodiment of the present invention. The handle 101 is operable to drive the chuck 100 that in turn rotates the bit 200.

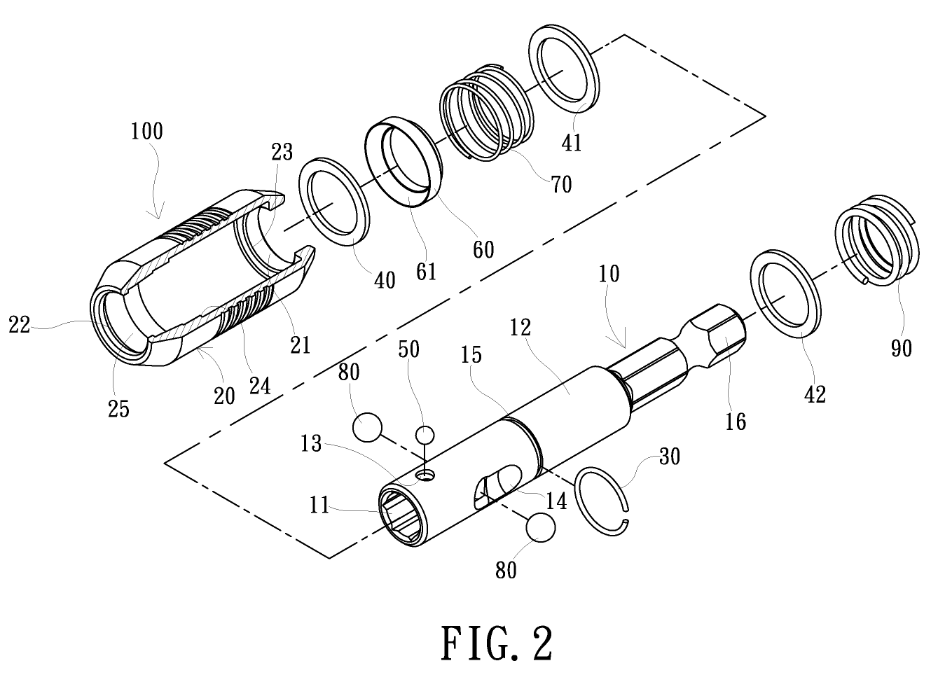

Referring to FIGS. 1 and 2, the chuck 100 includes a socket 10, a sleeve 20, a C-clip 30, three stopping rings 40, 41 and 42, a small ball 50, large balls 80, a pushing ring 60, and elastic elements 70 and 90. The socket 10 includes a recess 11 defined in an end, an aperture 13 in communication with the recess 11, two chutes 14 extended to the recess 11 from an external side 12 thereof, a groove 15 defined in the external side 12 and an insert 16 axially extended from an opposite end. In use, the recess 11 receives a first end of the bit 200 while a second end of the bit 200 is outside the recess 11. The recess 11 is shaped corresponding to the first end of the bit 200 that is preferably hexagonal. Each of the chutes 14 includes a front end 141 in communication with the recess 11 and a rear end 142 on the external side 12.

The sleeve 20 includes a front opening and a rear opening 21. The sleeve 20 includes an internal side formed with a shoulder 22 near the front opening, a shoulder 23 near the rear opening 21, a shoulder 24 between the shoulders 22 and 23 and a frustum-shaped face 25 between the shoulders 22 and 24. An internal diameter of a section of the sleeve 20 between the shoulders 22 and 24 is smaller than that of a section of the sleeve 20 between the shoulders 24 and 23. Therefore, the frustum-shaped face 25 gets larger as it extends towards the shoulder 24.

Referring to FIG. 3, the insert 16 is securely inserted in the handle 101. The sleeve 20 is located on the socket 10. The stopping rings 40, 41 and 42, the pushing ring 60, and the elastic elements 70 and 90 are located between the socket 10 and the sleeve 20. The stopping ring 41 is located against the shoulder 24. Each of the large balls 80 includes a portion located in a relative one of the chutes 14 and another portion located between the stopping ring 40 and a frustum-shaped internal side 61 of the pushing ring 60. The elastic element 70 is compressed between the pushing ring 60 and the stopping ring 41. The C-clip 30 is located in the groove 15, against the stopping ring 41. The stopping ring 42 is located against the C-clip 30. The elastic element 90 is compressed between the stopping ring 42 and the shoulder 23.

Each of the elastic elements 70 and 90 is preferably a helical spring made of a metal wire. The diameter of the metal wire of the elastic element 70 is smaller than that of the metal wire of the elastic element 90. Therefore, the elastic element 70 is loaded less than the elastic element 90 when they are compressed or extended for a same length.

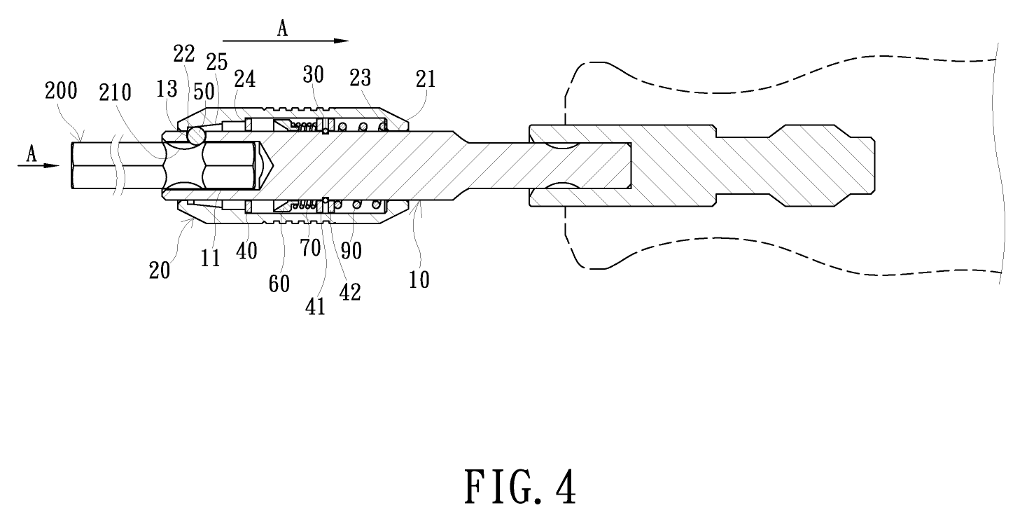

Referring to FIG. 4, the small ball 50 includes a portion located in the aperture 13 and another portion located against the shoulder 22. The diameter of the small ball 50 is larger than that of the aperture 13 so that the small ball 50 will not be dropped into the recess 11 through the aperture 13. However, a portion of the small ball 50 can be inserted into the recess 11 through the aperture 13.

Referring to FIGS. 3 and 4, a rear end of the bit 200 is inserted into the recess 11 in a sense of direction indicated with an arrow head A so that the rear end of the bit 200 moves the large balls 80 to the rear ends 142 of the chutes 14 from the front ends 141. A portion of the small ball 50 is inserted into a groove defined in the bit 200 so that the bit 200 is retained in the recess 11 for driving a fastener when the handle 101 is operated. The small ball 50 includes a portion abutted against the shoulder 22 and another portion abutted against the frustum-shaped face 25.

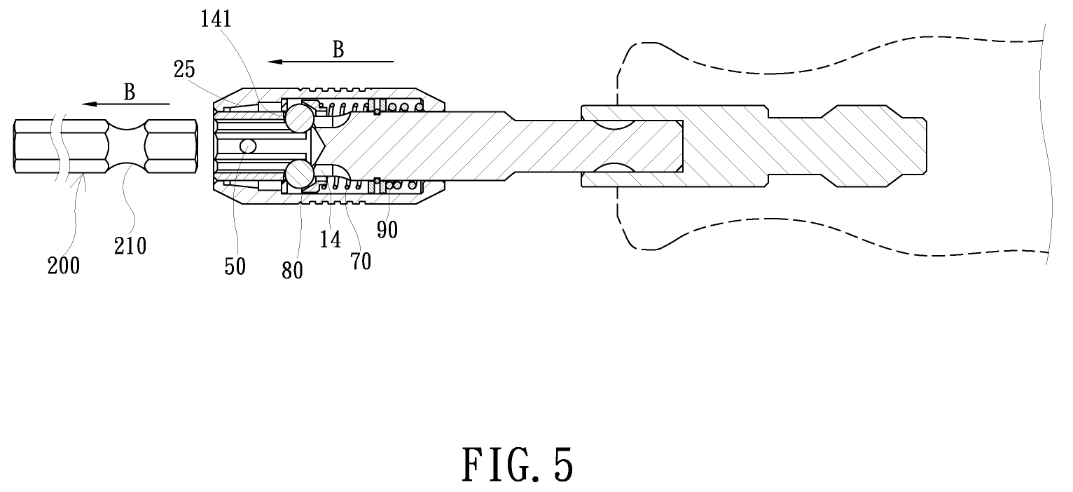

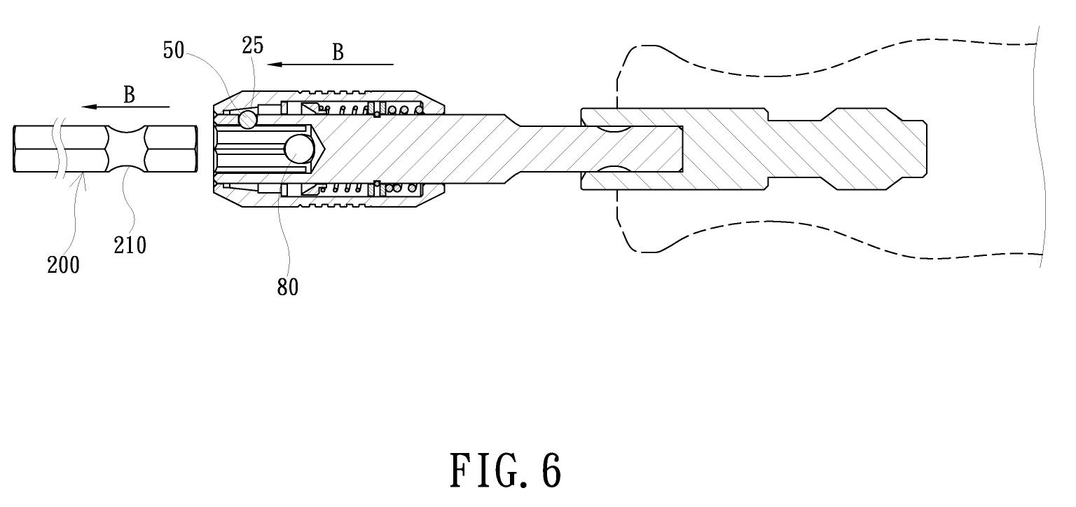

Referring to FIGS. 5 and 6, the sleeve 20 is moved in a sense of direction indicated with an arrow head B, thus removing the frustum-shaped face 25 from the small ball 50. Hence, the small ball 50 can be further moved into a gap defined between the socket 10 and the sleeve 20, i.e., the small ball 50 can be removed from the recess 11 and the groove 210 of the bit 200. By pulling, the bit 200 is released from the small ball 50, and the rear end of the bit 200 from the recess 11. As the rear end of the bit 200 is removed from the recess 11, the large balls 80 are released from the rear end of the bit 200. Biased with the elastic element 70, the pushing ring 60 returns the large balls 80 to the front ends 141 of the chutes 14. Hence, the large balls 80 are retained in position.

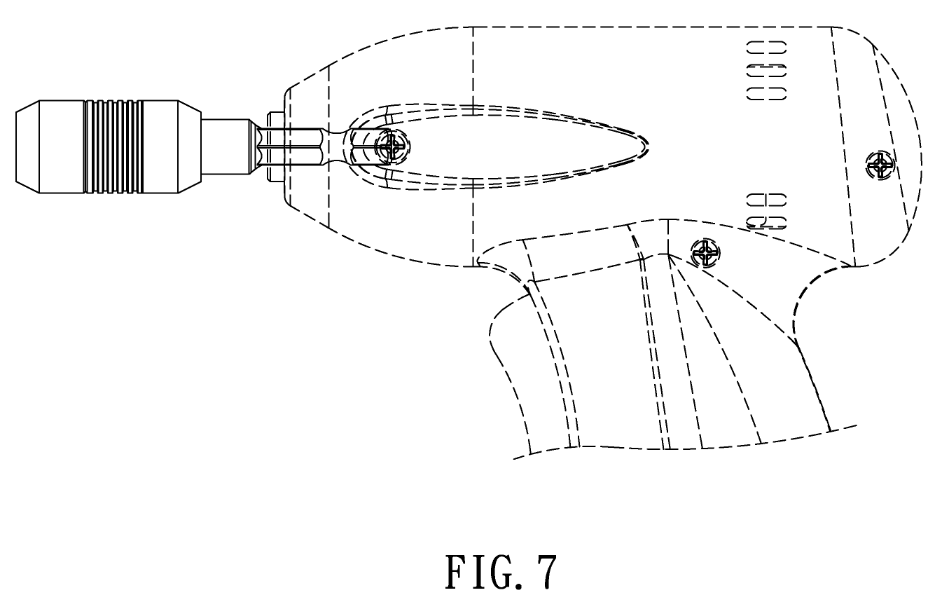

Referring to FIG. 7, there is shown a tool according to a second embodiment of the present invention. The second embodiment is like the first embodiment except including an electric or pneumatic driving device 300 instead of the handle 101.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A tool comprising a handle and a chuck comprising:
a socket comprising a recess defined therein, an aperture in communication with the recess, chutes in communication with the recess, and a groove defined in an external side;
a sleeve located on the socket, wherein the sleeve comprises front, middle and rear shoulders formed on an internal side so that an internal diameter of a section thereof between the front and middle shoulders is smaller than that of a section thereof between the middle and rear shoulders;
a C-clip located in the groove;
first, second and third stopping rings located between the socket and the sleeve so that the first stopping ring is abutted against the front shoulder and that the C-clip is located between the second and third stopping rings;
a small ball located in the aperture and restrained with the front shoulder;
large balls movably located in the chutes;
a pushing ring located between the socket and the sleeve, against the large balls; and
first and second elastic elements located between the socket and the sleeve so that the first elastic element is compressed between the second stopping ring and the pushing ring and that the second elastic element is compressed between the third stopping ring and the rear shoulder.

2. The tool according to claim 1, wherein the sleeve comprises a frustum-shaped face formed next to the front shoulder and used for contact with the small ball.

3. The tool according to claim 1, wherein the first elastic element is a helical spring.

4. The tool according to claim 1, wherein the second elastic element is a helical spring.

5. The tool according to claim 1, wherein the pushing ring comprises a frustum-shaped internal side for contact with the small ball.

6. The tool according to claim 1, wherein each of the chutes of the socket comprises a front end in communication with the recess and a rear end so that a related one of the big balls can be restrained in a selected one of the front and rear ends.

7. The tool according to claim 1, wherein the recess of the socket is hexagonal.
